(19) United States
(12) Patent Application Publication
(10) Pub. No.: US 2012/0296758 A1
(43) Pub. Date: Nov. 22, 2012

(54) ITERATIVE AUCTION SYSTEM AND METHOD

(76) Inventors: Brendan A. Smith, Beverly, MA (US); Patrick B. Gillis, Beverly, MA (US)

(21) Appl. No.: 13/109,591

(22) Filed: May 17, 2011

(51) Int. Cl. G06Q 30/00

(52) U.S. Cl. 705/26.3

(57) ABSTRACT

A method, computer program product, and computing system for defining an entry fee for an online auction for an auctioned product. One or more users are registered for participation in the online auction. The entry fee is collected from each of the registered user, wherein payment of the entry fee is required to participate in the online auction.

### TECHNICAL FIELD

This disclosure relates to auction systems and methods and, more particularly, to iterative auction systems and methods.

### BACKGROUND

In the not-so-distant past, in the event that someone wanted to sell an item/product, they typically would resort to traditional advertising mediums (e.g. print-based, radio-based and/or television-based advertisements). However, with the advent of the Internet and the proliferation of worldwide Internet access, new modalities of selling items/products became available to the general masses. For example, traditional newspaper-based classified ads transitioned to Internet-based classified webpages (e.g. craigslist.com). Further, online auctions (e.g. eBay.com) became a new methodology for retailers, resellers and individuals to sell product.

Unfortunately, online auction websites may not hold a buyer's interest for a long period of time due to the traditional manner in which the auctions are defined. For example, when configuring an online auction, the seller typically defines the length of an auction (which is often several days to a month in length). Accordingly, when potential buyers visit such an auction site, they may see a product that they are interested in. However, upon noticing that the auction will not end for e.g. two weeks, the user may decide that it is better to revisit the auction sometime around the end of the defined auction period to determine the status of the item being sold. Unfortunately and as would be expected, users often lose track of/forget about the auction in question and, therefore, fail to obtain the products sought.

### SUMMARY OF THE DISCLOSURE

In a first implementation, a computer-implemented method includes defining an entry fee for an online auction for an auctioned product. One or more users are registered for participation in the online auction. The entry fee is collected from each of the registered user, wherein payment of the entry fee is required to participate in the online auction.

One or more of the following features may be included. A required participants parameter may be defined for the online auction for the auctioned product. If it is determined that the required participants parameter was met, the online auction may be initiated. If the required participants parameter was not met, one of more of the following operations may be performed: the online auction for the auctioned product may be cancelled; and the time for meeting the required participants parameter may be extended. The required participants parameter and the entry fee may be configured to cover the cost of the auctioned product. The online auction may include a plurality of timed rounds. One or more incrementing bids may be processed, wherein an incrementing bid is a bid placed by a first user that increments a first user's bid value with respect to all other users' bid values. One or more decrementing bids may be processed, wherein a decrementing bid is a bid placed by a first user that decrements a second user's bid value with respect to all users' bid values.

In another implementation, a computer program product resides on a computer readable medium and has a plurality of instructions stored on it. When executed by a processor, the instructions cause the processor to perform operations including defining an entry fee for an online auction for an auctioned product. One or more users are registered for participation in the online auction. The entry fee is collected from each of the registered user, wherein payment of the entry fee is required to participate in the online auction.

One or more of the following features may be included. A required participants parameter may be defined for the online auction for the auctioned product. If it is determined that the required participants parameter was met, the online auction may be initiated. If the required participants parameter was not met, one of more of the following operations may be performed: the online auction for the auctioned product may be cancelled; and the time for meeting the required participants parameter may be extended. The required participants parameter and the entry fee may be configured to cover the cost of the auctioned product. The online auction may include a plurality of timed rounds. One or more incrementing bids may be processed, wherein an incrementing bid is a bid placed by a first user that increments a first user's bid value with respect to all other users' bid values. One or more decrementing bids may be processed, wherein a decrementing bid is a bid placed by a first user that decrements a second user's bid value with respect to all users' bid values.

In another implementation, a computing system includes at least one processor and at least one memory architecture coupled with the at least one processor.

A first software module is executed on the at least one processor and the at least one memory architecture. The first software module is configured to perform operations including defining an entry fee for an online auction for an auctioned product. A second software module is executed on the at least one processor and the at least one memory architecture. The second software module is configured to perform operations including registering one or more users for participation in the online auction. A third software module is executed on the at least one processor and the at least one memory architecture. The third software module is configured to perform operations including collecting the entry fee from each of the registered user, wherein payment of the entry fee is required to participate in the online auction.

One or more of the following features may be included. A required participants parameter may be defined for the online auction for the auctioned product. If it is determined that the required participants parameter was met, the online auction may be initiated. If the required participants parameter was not met, one of more of the following operations may be performed: the online auction for the auctioned product may be cancelled; and the time for meeting the required participants parameter may be extended. The required participants parameter and the entry fee may be configured to cover the cost of the auctioned product. The online auction may include a plurality of timed rounds. One or more incrementing bids may be processed, wherein an incrementing bid is a bid placed by a first user that increments a first user's bid value with respect to all other users' bid values. One or more decrementing bids may be processed, wherein a decrementing bid is a bid placed by a first user that decrements a second user's bid value with respect to all users' bid values.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an auction process coupled to a distributed computing network;

FIG. 2 is a flowchart of the auction process of FIG. 1; and

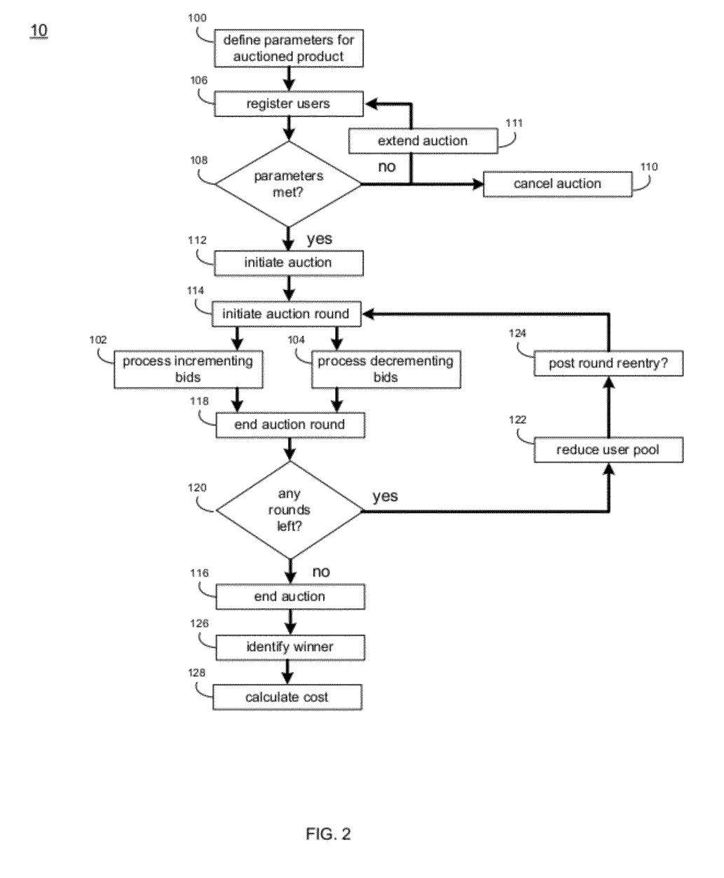

FIG. 3 is a diagrammatic view of a webpage rendered by the auction process of FIG. 1.

Like reference symbols in the various drawings indicate like elements.

### DETAILED DESCRIPTION OF THE PREFERRED EMBODIMENTS

### System Overview

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions/software modules. These computer program instructions/modules may be provided to a processor of a general purpose computer, special purpose computer, or other programmable data processing apparatus to produce a machine, such that the instructions/modules, which execute via the processor of the computer or other programmable data processing apparatus, create means for implementing the functions/acts specified in the flowchart and/or block diagram block or blocks.

These computer program instructions/modules may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions/modules may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

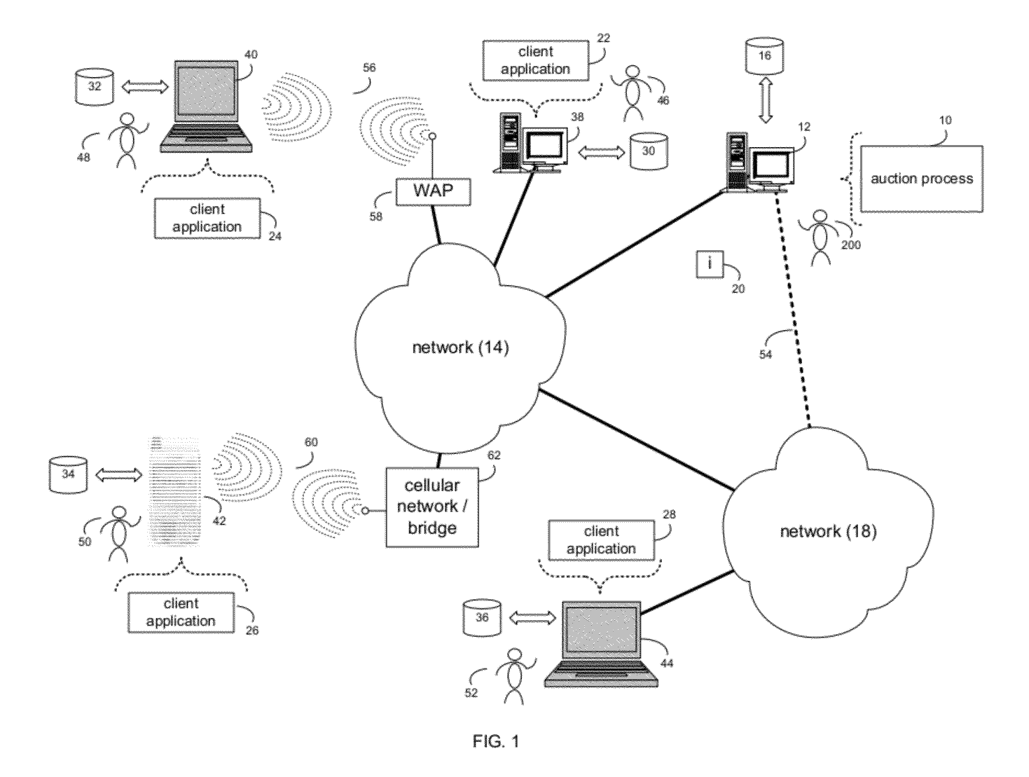

Referring to FIGS. 1 & 2, there is shown auction process 10 that may reside on and may be executed by computing system 12, which may be connected to network 14 (e.g., the Internet or a local area network). Examples of computing system 12 may include, but are not limited to: a personal computer, a server computer, an array of server computers, a mini computer, a mainframe computer, and all or a portion of a computing cloud. One or more components of computing system 12 may execute one or more operating systems, examples of which may include but are not limited to: Microsoft Windows XP Server™; Novell Netware™; Redhat Linux™, Unix, or a custom operating system, for example.

As will be discussed below in greater detail, auction process 10 may allow parameters to be defined 100 for a particular auctioned product, wherein incrementing bids may be processed 102 that bolster the likelihood of a user winning the auctioned product, while decrementing bids may be processed 104 that lessen the likelihood of a user winning the auctioned product.

The instruction sets and subroutines of auction process 10, which may be stored on storage device 16 included within computing system 12, may be executed by one or more processors (not shown) and one or more memory architectures (not shown) included within computing system 12. Storage device 16 may include but is not limited to: a hard disk drive; a tape drive; an optical drive; a RAID array; a random access memory (RAM); a read-only memory (ROM); and a flash memory.

Network 14 may be connected to one or more secondary networks (e.g., network 18), examples of which may include but are not limited to: a local area network; a wide area network; or an intranet, for example.

Various auction instructions (e.g. auction instruction 20) may be sent from client applications 22, 24, 26, 28 to auction process 10. As will be discussed below in greater detail, examples of auction instruction 20 may include but are not limited to entry fee instructions (i.e. instructions that pay an entry fee for a user to participate in an auction for a specific auctioned item), incrementing bid instructions (i.e., instructions that increment the amount that the user has personally bid on the specific auctioned item), and decrementing bid instructions (i.e. instructions that decrement the amount that a third party has bid on the specific auctioned item).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), and all forms of flash memory storage devices.

Examples of client electronic devices 38, 40, 42, 44 may include, but are not limited to, personal computer 38, laptop computer 40, personal digital assistant 42, notebook computer 44, a server (not shown), a data-enabled, cellular telephone (not shown), and a dedicated network device (not shown). Client electronic devices 38, 40, 42, 44 may each execute an operating system, examples of which may include but are not limited to Microsoft Windows™, Microsoft Windows CE™, Redhat Linux™, or a custom operating system.

Users 46, 48, 50, 52 may access auction process 10 directly through network 14 or through secondary network 18. Further, computing system 12 may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14.

WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Auction Process:

As discussed above, auction process 10 may allow parameters to be defined 100 for a particular auctioned product, wherein incrementing bids may be processed 102 that bolster the likelihood of a user winning the auctioned product, while decrementing bids may be processed 104 that lessen the likelihood of a user winning the auctioned product.

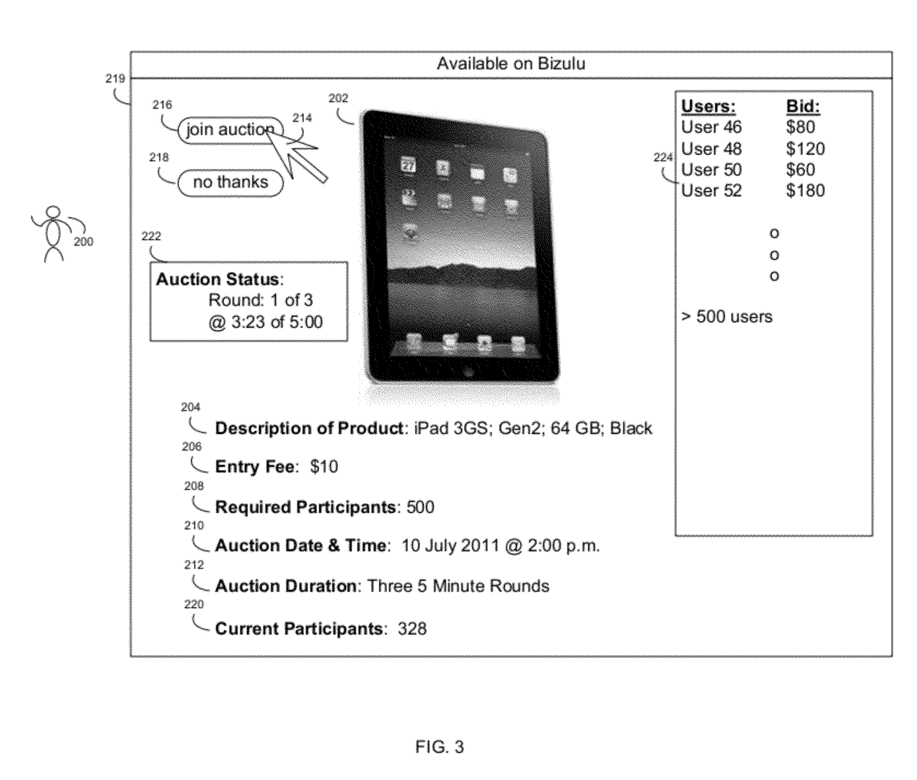

For example and referring also to FIG. 3, an administrator (e.g. administrator 200) of auction process 10 may define 100 one or more parameters for a particular auctioned product (e.g. auctioned product 202). For example, through auction process 10, administrator 200 may define 100: product description 204; entry fee 206; required participants 208; auction date & time 210; and auction duration 212.

For example, assume that administrator 200 has an Apple iPad that they wish to auction using auction process 10. Accordingly and through auction process 10, administrator 200 may define 100 product description 204 as “iPad 3GS, Gen2, 64 GB, black”. Additionally, administrator 200 may define 100, via auction process 10, entry fee 206. In this particular example, entry fee 206 is defined as being $10, which is the fee paid by the user when registering for the auction. Entry fee 206 is typically non-refundable. Accordingly, whether the registered user wins or loses the subject auction, the registered user still must pay the entry fee.

While the system is described above as a system in which the auction is being initiated by an administrator of a product that is owned by e.g., the employer of the administrator, this is for illustrative purposes only and is not intended to be a limitation of this disclosure, as other configurations are possible and are considered to be within the scope of this disclosure. For example, auction process 10 may be configured to allow third parties to sell their own products in a fashion similar to that of other online auction sites. Accordingly and is such a configuration, auctioned product 202 may be provided by the third party and auction process 10 may be configured to allow the third party to define the above-referenced parameters for the particular auctioned product (e.g. auctioned product 202). Administrator 200 may further define 100, via auction process 10, the required participants 208 needed to allow the auctioned to precede. When administrator 200 defines the various parameters of an auction, entry fee 206 and required participants 208 may be defined in such a fashion to ensure that the resulting auction is profitable for e.g. administrator 200, the owners of auction process 10 and/or the entity hosting the auction of auctioned product 202. For example, if at least 500 participants are each required to pay a $10 entry fee to participate in an auction of auction product 202, at least $5,000 of revenue will be generated, thus covering the cost of auction product 202.

While the entry fee is described above as being a static entry fee, this is for illustrative purposes only and is not intended to be a limitation of this disclosure, as other configurations are possible and are considered to be within the scope of this disclosure. For example, the entry fee may be configured in a sliding fashion, in that the entry fee changes as users register for the auction. For example, auction process 10 may be configured so that the entry fee is initially lower to induce users into registering for the auction earlier than they may be inclined to do so. For example, auction process 10 may be configured so that the first 100 users that register for the auction my save 50% on the entry fee. Alternatively, auction process 10 may be configured so that the users that register for the auction within the first two hours of the auction being available for registration may save 50% on the entry fee. Conversely, the entry fee may be configured so that the entry fee is reduced as additional people register for the auction. For example, if only 500 people register for the auction, the entry fee may be $10 each. However, if 1,000 people register for the auction, auction process 10 may be configured to reduce the entry fee to $8; and if 5,000 people register for the auction, auction process 10 may be configured to reduce the entry fee to $5.

Administrator 200 may further define 100, via auction process 10, an auction date & time 210 at which point the subject auction for auctioned product 202 will begin. Additionally, administrator 200 may further define, via auction process 10, auction duration 212, which may define e.g. the number of rounds included in the subject auction and the duration of each round (to be discussed below in greater detail).

As discussed above, auction process 10 may be configured to allow third parties to sell their own products in a fashion similar to that of other online auction sites. Accordingly and is such a configuration, the above-referenced third party may define some or all of the above-referenced parameters for the particular auctioned product (e.g. auctioned product 202). For example, the third party may offer auctioned product 202 up for auction. Via auction process 10, the above-referenced third party may indicate that they are willing to accept a minimum of $500 for auctioned product 202 and may define an entry fee of $10. Accordingly, auction process 10 may determine that the minimum number of required participants is 50, as 50 participants @ $10 per participant generates $500 in revenue.

Continuing with the above stated example, assume that users 46, 48, 50, 52, all review the auction website (e.g. www.bizulu.com) that is hosting the auction for auctioned product 202. Further, assume for illustrative purposes that each of the users 46, 48, 50, 52 decides that they want to join the auction for auctioned product 202. Accordingly, each of users 46, 48, 50, 52 may select, via on-screen pointer 214, “join auction” button 216 and auction process 10 will register 106 the appropriate users for the auction in question. Alternatively, if any of users 46, 48, 50, 52 are not interested in joining the auction for auctioned product 202, the users may select, via on-screen pointer 214, “no thanks” button 218.

While auction process 10 is shown to include one auctioned product (e.g. auctioned product 202), this is for illustrative purposes only and is not intended to be a limitation of this disclosure. Specifically and typically, auction process 10 may host a plurality of auctions that are currently auctioning/will be auctioning a plurality of auctioned products.

The information screen 219 concerning auction product 202 may further include a “Current Participants” field 220 that identifies the total number of users who have registered 106 for the subject auction concerning e.g., auctioned product 202. Accordingly, each time a user (e.g., one or more of users 46, 48, 50, 52) registers 106 for the auction concerning auctioned product 202, “Current Participants” field 220 may be incremented to represent the newly-registered users for the auction.

Whenever a user selects “join auction” button 216, auction process 10 may collect funds from an auction account belonging to the registering user to pay for above-described entry fee 206. For example, when first using the auction site (e.g. www.bizulu.com) that is hosting the auction for auctioned product 202, the user may be required to establish an auction account. When establishing an auction account, the user may be required to e.g., define a username, define a password, define an e-mail address, and fund their account. For example, the user may be required to transfer money into their auction account with e.g. PayPal, a credit card, or an EFT from a bank account. The balance of this account may be in dollars or in some form of auction credits. For example, auction process 10 may allow the user to purchase individual auction credits for one dollar each. Auction process 10 may further allow the user to purchase larger quantities of credits (e.g. 50 credits) at a reduced rate ($40).

As discussed above and through auction process 10, administrator 200 may define 100: the required participants 208 needed to allow the auction to precede; and an auction date & time 210 (which defines when the subject auction for auctioned product 202 will begin). In this particular example, auction date & time 210 is shown to be “10 Jul. 2011 @ 2:00 PM”. Accordingly, once this deadline is achieved, auction process 10 may determine 108 whether the previously defined 100 parameters for the subject auction have been met. Accordingly, auction process 10 may determine 108 whether or not the minimum number of required participants (e.g. 500) signed up for the subject auction. In the event that the minimum number of required participants did not sign up, auction process 10 may be configured to perform one or more functions, such as cancelling 110 the subject auction or extending 111 auction date & time 210 for a defined period of time to allow more users to register for the subject auction. Additionally/alternatively, in the event that the number of users registered for the auction greatly exceeds the minimum number of required participants 208, auction process 10 may be configured to perform one or more complimentary functions. As discussed above and for this example, the minimum number of required participants 208 is 500 users. Accordingly, in the event that the number of registered users far exceeds the minimum number required participants (e.g. 1,000 users have registered), auction process 10 may be configured to add one or more additional prizes to the subject auction. For example, auction process 10 may be configured to add a second iPad to the subject auction, such that the first and second place winners of the subject auction may each win an iPad. Alternatively, auction process 10 may be configured to add an additional complementary accessory to the subject auction, such that e.g., the winner of the auction wins the iPad plus an accessory package (e.g. a cover, a wireless keyboard, and an iTunes gift card).

Continuing with the above stated example, assume for illustrative purposes that at the defined auction date & time 210, the number of users registered for the auction exceeds the minimum number of required participants (e.g. 500). Accordingly, auction process 10 may initiate 112 the subject auction. At this point in time, “join auction” button 216 and “no thanks” button 218 may be “grayed out” (i.e. or made unavailable), thus preventing any additional users from joining the subject auction. Accordingly, auction process 10 may be configured so that users are only allowed to register for an auction up to the time that the auction starts (and not after the action starts).

While the system is described above as requiring the auction deadline (e.g., “10 Jul. 2011 @2:00 PM” as defined by auction date & time 210) to be achieved prior to the initiation 112 of the subject auction, this is for illustrative purposes only and is not intended to be a limitation of this disclosure, as other configurations are possible and are considered to be within the scope of this disclosure. For example, auction process 10 may compare the number of users registered for the auction to the minimum number of required participants 208 and immediately start the subject auction upon the number of users registered for the auction equaling/exceeding the minimum number of required participants 208.

Additionally, once the auction is initiated 112, auction process 10 may render an auction status window 222 that defines e.g. the current round of the auction (“Round: 1 of 3” and the current timing of the current round (“@3:23 of 5:00”).

Further, once the auction is initiated 112, auction process 10 may render a registered users window 224 that defines e.g. the identities and current bids of the users participating in the auction. While in this example, registered users window 224 is shown to identify only four users (e.g. users 46, user 48, user 50, user 52), this is for illustrative purposes and is not intended to be a limitation of this disclosure. For example, as the number of required participants is 500, it is foreseeable that registered user window 224 would define at least 500 registered users (or a portion thereof).

As discussed above, administrator 200 may define 100 auction duration 212, which may define e.g. the number of rounds included in the auction and the length of each round. Assume for illustrative purposes only that this auction will include three rounds at 5 minutes each. However, it is foreseeable that the number and duration of rounds may vary based upon several factors. For example, auction process 10 may be configured to vary the number of rounds based upon the number of users registered for the subject action. Accordingly, a minimum of three rounds may be defined, with an additional round added for each 500 users that register over-and-above the required number of registered users. Auction system 10 may be configured to make similar adjustments to the duration of each round included within the subject auction.

Continuing with the above-stated example, auction process 10 may initiate 114 the first round of (in this example) the three round subject auction. At this point in time, the various users that have registered 106 to join the subject auction will be able to place various types of bids via auction process 10, such as incrementing bids and decrementing bids.

Incrementing Bids:

An incrementing bid is generally a traditional auction bid that directly increases the pending bid of a user for an auctioned item. For example, at the time the subject auction is initiated, the total value of each user's bid is $0.00. And when auction process 10 subsequently ends 116 the subject auction (after the expiry of the defined rounds), the user with the highest total bid wins the item up for auction (in this case, the iPad). Accordingly, if user 46 is willing to pay $30 for the iPad, they may bid $30. However, if user 48 is willing to pay $40 for the iPad, they may bid $40 (thus surpassing the bid of user 46 by $10). Each user participating in the subject auction may incrementally increase their bids (typically by a defined amount; e.g., $1) until the auction ends. Therefore, in the event that the auction ended at this time, user 48 would win the iPad with a bid of $40.

Decrementing Bids:

A decrementing bid functions very differently from that of an incrementing bid. For example, while an incrementing bid increments the value of your bid with respect to everyone else's bid, a decrementing bid decrements the value of a third party's bid with respect to everyone else's bid. Accordingly, a decrementing bid is essentially an attack on someone else's bid. Therefore, when a first user makes a decrementing bid, they must define the amount of the decrementing bid and the target of the decrementing bid. Accordingly, if user 46 places a $10 decrementing bid against user 48, this $10 decrementing bid WILL NOT RAISE the value of the current bid of user 46 by $10 . . . but WILL LOWER the value of the current bid of user 48 by $10.

For example, assume that when the subject auction is initiated 112 and, therefore, the first round of the subject auction is also initiated 114, users 46, 48, 50, 52 each place an incrementing bid of $60. As discussed above, incrementing bids increment the value of a user's bid with respect to everyone else's bid. At this point in time, the status of the bids will be as follows:

| User 46 | User 48 | User 50 | User 52 |
|---|---|---|---|
| $60 | $60 | $60 | $60 |

Now, assume that user 48 places an incrementing bid of an additional $60 and user 50 and user 52 each place an incrementing bid of an additional $120. As discussed above, incrementing bids increment the value of a user's bid with respect to everyone else's bid. At this point in time, the status of the bids will be as follows:

| User 46 | User 48 | User 50 | User 52 |
|---|---|---|---|
| $60 | $60 + $60 → $120 | $60 + $120 → $180 | $60 + $120 → $180 |

Now, assume that users 46, 48 each place a decrementing bid of $60 (for a total of $120) with respect to user 50. As discussed above, decrementing bids made by one of more users (e.g., users 46, 48) decrement the value of a third party's bid (e.g., user 50) with respect to everyone else's bid (e.g., users 46, 48, 52). At this point in time, the status of the bids will be as follows:

| User 46 | User 48 | User 50 | User 52 |
|---|---|---|---|
| $60 | $120 | $180 − $120 → $60 | $180 |

Now, assume that user 46 places an incrementing bid of an additional $20. As discussed above, incrementing bids increment the value of a user's bid with respect to everyone else's bid. At this point in time, the status of the bids will be as follows:

| User 46 | User 48 | User 50 | User 52 |
|---|---|---|---|
| $60 + $20 → $80 | $120 | $60 | $180 |

The processing 102 of incrementing bids and the processing 104 of decrementing bids may continue until auction process 10 ends 118 the current round of the subject auction. As discussed above, assume for illustrative purposes only that the subject auction includes three rounds of 5 minutes each. Accordingly, after 5 minutes of bidding, auction process 10 may end 118 the first round of the subject auction. One ended 118, auction process 10 may determine 120 whether any additional rounds of the subject auction need to be completed. As this auction contains three rounds and only one round has been completed, auction process 10 may continue the auction and initiate 114 round two of the subject auction.

Prior to initiating 114 the second round of the subject auction, auction process 10 may reduce 122 the user pool by eliminating/removing a portion of the users who registered to participate in the subject auction. For example, auction process 10 may be configured by administrator 200 to reduce 122 the user pool by removing e.g., the lower 50% of the registered users from the subject auction, thus preventing the lower 50% from continuing to bid in the subject auction. Auction process 10 may determine members of this lower 50% based upon the value of each user's current bid at the time that the auction round was ended 118 by auction process 10.

Accordingly and assuming that the subject auction had 500 registered users, upon the ending 118 of the first round of the subject auction, auction process 10 may remove/eliminate the users with the 250 lowest bids. Accordingly and at this point time in the auction, the number of registered users participating in the subject auction may be reduced 122 to 250 by auction process 10.

At this point in time, auction process 10 may be configured (by administrator 200) to offer 124 a post round reentry option to a portion of those users that were eliminated from the registered users list for the subject auction. The manner in which this offer 124 is made by auction process 10 may vary depending upon the manner in which auction process 10 is configured by administrator 200. For example, auction process 10 may offer 124 this post round reentry option to e.g. the top 10 highest bids included within the 250 removed/eliminated users, wherein a bid is calculated as follows: total incrementing bids−total decrementing bids received (i.e., decrementing bids that targeted you). Alternatively, auction process 10 may offer 124 this post round reentry option to e.g. a percentage of the 250 users removed/eliminated from the subject auction.

Depending on the manner in which auction process 10 is configured, any users that accept the offer 124 of post round reentry may be required to pay a reentry fee, such as two credits or $2. If the user accepts the offer 124 for post round reentry, auction process 10 may collect the reentry fee from the auction account belonging to the user.

The processing 102 of incrementing bids, the processing 104 of decrementing bids, and determining 120 whether any additional rounds of the subject auction need to be completed may continue until auction process 10 ends 116 the subject auction (i.e., once all rounds of the auction have been completed).

Additionally, auction process 10 may continue to reduce 122 the user pool between each set of rounds of the subject auction. As discussed above, auction process 10 may be configured by administrator 200 to remove the lower 50% of the registered users between each consecutive set of rounds included within the subject auction. This reduction 122 of the user pool may be based upon the value of each user's current bid at the time that the auction round was ended 118 by auction process 10.

For example, if the subject auction contains three rounds, between round one and round two, the number of registered users may be cut in half (e.g. from 500 to 250, namely 50% of original). Further, between round two and round three, the number of registered users may again be cut in half (e.g. from 250 to 125, namely 25% of original). Additionally, auction process 10 may continue to offer 124 a post round reentry option between each set of rounds of the subject auction.

Once the subject auction has ended 116, auction process 10 may identify 126 the identity of the winner of the subject auction and calculate 128 the total cost owed by the winner of the auction. When identifying 126 the winner of the subject auction, auction process 10 may simply determine the user who has the highest bid, wherein a bid is calculated as follows: total incrementing bids−total decrementing bids received (i.e., decrementing bids that targeted you).

Continuing with the above-stated example, assume that the bids at the time that the subject auction ended were as follows:

| User 46 | User 48 | User 50 | User 52 |
|---|---|---|---|
| $80 | $120 | $60 | $180 |

Accordingly, auction process 10 may identify 126 the winner of the subject auction (i.e., the bidder with the highest bid) as user 52, with a winning bid of $180 (i.e., total incrementing bids of $60+$120−total decrementing bids received of $0). When calculating 128 the cost to (i.e., amount owed by) user 52, the cost may be calculated as follows:

total cost=entry fee+total incrementing bids+total decrementing bids initiated−total decrementing bids recieved

Accordingly and for user 52, the total cost is as follows:

total cost=$10+$180+$0 (decrementing bids initiated)−$0 (in decrementing bids received)

Therefore, user 52 would have a total cost of $190, of which (as discussed above) auction process 10 may have previously collected $10 from the above-described auction account associated with user 52. Accordingly, auction process 10 may collect the residual amount due (namely $180) via any traditional payment means (e.g. PayPal, a credit card, or an EFT from a bank account). Alternatively, auction process 10 may be configured to collect the residual amount due (namely $180) from the above-described auction account associated with user 52.

As discussed above, auction process 10 is typically configured so that entry fee 206 is typically non-refundable. Accordingly, whether the registered user wins or loses the subject auction, the registered user must still pay the entry fee. However, auction process 10 is typically configured so that only the winner of the subject auction is required to pay the incrementing bid value and the decrementing bid value. Accordingly, since users 46, 48, 50 did not win the subject auction, they are not required to pay anything over and above the e.g., $10 entry fee. Therefore, they are not required to pay the incrementing bid values and the decrementing bid values. However and for informational purposes only, if any of users 46, 48, 50 had won the subject auction, their respective costs would be calculated as follows:

total cost=entry fee+total incrementing bids+total decrementing bids initiated−total decrementing received

Accordingly and for user 46, the total cost (had they won) would be as follows:

total cost=$10+$80+$60 (one decrementing bid initiated against user 50)−$0 (in decrementing bids received)

Accordingly and for user 48, the total cost (had they won) would be as follows:

total cost=$10+$120+$60 (one decrementing bid initiated against user 50)−$0 (in decrementing bids received)

Accordingly and for user 50, the total cost (had they won) would be as follows:

total cost=$10+$180+$0 (decrementing bids initiated)−$120 (in decrementing bids received)

Accordingly, user 46 would have had a total cost of $150 (if they had won); user 48 would have had a total cost of $190 (if they had won); and user 50 would have had a total cost of $70 (if they had won).

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
defining an entry fee for an online auction for an auctioned product;
registering one or more users for participation in the online auction; and
collecting the entry fee from each of the registered user, wherein payment of the entry fee is required to participate in the online auction.

2. The computer-implemented method of claim 1 further comprising:
defining a required participants parameter for the online auction for the auctioned product;
determining if the required participants parameter was met; and
if the required participants parameter was met, initiating the online auction.

3. The computer-implemented method of claim 2 further comprising:
if the required participants parameter was not met, performing one of more of the following operations:
cancelling the online auction for the auctioned product; and
extending the time for meeting the required participants parameter.

4. The computer-implemented method of claim 2 wherein the required participants parameter and the entry fee are configured to cover the cost of the auctioned product.

5. The computer-implemented method of claim 1 wherein the online auction includes a plurality of timed rounds.

6. The computer-implemented method of claim 1 further comprising:
processing one or more incrementing bids, wherein an incrementing bid is a bid placed by a first user that increments a first user's bid value with respect to all other users' bid values.

7. The computer-implemented method of claim 1 further comprising:
processing one or more decrementing bids, wherein a decrementing bid is a bid placed by a first user that decrements a second user's bid value with respect to all users' bid values.

8. A computer program product residing on a computer readable medium having a plurality of instructions stored thereon which, when executed by a processor, cause the processor to perform operations comprising:
defining an entry fee for an online auction for an auctioned product;
registering one or more users for participation in the online auction; and
collecting the entry fee from each of the registered user, wherein payment of the entry fee is required to participate in the online auction.

9. The computer program product of claim 8 further comprising instructions for performing operations including:
defining a required participants parameter for the online auction for the auctioned product;
determining if the required participants parameter was met; and
if the required participants parameter was met, initiating the online auction.

10. The computer program product of claim 9 further comprising instructions for performing operations including:
if the required participants parameter was not met, performing one of more of the following operations:
cancelling the online auction for the auctioned product; and
extending the time for meeting the required participants parameter.

11. The computer program product of claim 9 wherein the required participants parameter and entry fee are configured to cover the cost of the auctioned product.

12. The computer program product of claim 8 wherein the online auction includes a plurality of timed rounds.

13. The computer program product of claim 8 further comprising instructions for performing operations including:
processing one or more incrementing bids, wherein an incrementing bid is a bid placed by a first user that increments a first user's bid value with respect to all other users' bid values.

14. The computer program product of claim 8 further comprising instructions for performing operations including:
processing one or more decrementing bids, wherein a decrementing bid is a bid placed by a first user that decrements a second user's bid value with respect to all users' bid values.

15. A computing system comprising:
at least one processor;
at least one memory architecture coupled with the at least one processor;
a first software module executed on the at least one processor and the at least one memory architecture, wherein the first software module is configured to perform operations including defining an entry fee for an online auction for an auctioned product;
a second software module executed on the at least one processor and the at least one memory architecture, wherein the second software module is configured to perform operations including registering one or more users for participation in the online auction; and
a third software module executed on the at least one processor and the at least one memory architecture, wherein the third software module is configured to perform operations including collecting the entry fee from each of the registered user, wherein payment of the entry fee is required to participate in the online auction.

16. The computing system of claim 1 further comprising a fourth software module executed on the at least one processor and the at least one memory architecture, wherein the fourth software module is configured to perform operations including:
defining a required participants parameter for the online auction for the auctioned product;
determining if the required participants parameters was met; and
if the required participants parameter was met, initiating the online auction.

17. The computing system of claim 2 further comprising a fifth software module executed on the at least one processor and the at least one memory architecture, wherein the fifth software module is configured to perform operations including:
if the required participants parameter was not met, performing one of more of the following operations:
cancelling the online auction for the auctioned product; and
extending the time for meeting the required participants parameter.

18. The computing system of claim 1 wherein the required participants parameter and the entry fee are configured to cover the cost of the auctioned product.

19. The computing system of claim 1 wherein the online auction includes a plurality of timed rounds.

20. The computing system of claim 1 further comprising a sixth software module executed on the at least one processor and the at least one memory architecture, wherein the sixth software module is configured to perform operations including:
processing one or more incrementing bids, wherein an incrementing bid is a bid placed by a first user that increments a first user's bid value with respect to all other users' bid values.

21. The computing system of claim 1 further comprising a seventh software module executed on the at least one processor and the at least one memory architecture, wherein the seventh software module is configured to perform operations including:
processing one or more decrementing bids, wherein a decrementing bid is a bid placed by a first user that decrements a second user's bid value with respect to all users' bid values.
